(19) United States
(12) Patent Application Publication
(10) Pub. No.: US 2022/0350302 A1
(43) Pub. Date: Nov. 3, 2022

(54) MARKER DEVICE FOR USE WITH A CNC LAYOUT TABLE

(71) Applicant: NICHOLAS J. DONNER, LINCOLN, NE (US)

(72) Inventor: NICHOLAS J. DONNER, LINCOLN, NE (US)

(21) Appl. No.: 16/778,077

(22) Filed: Jan. 31, 2020

(51) Int. Cl. G05B 19/18; B43K 23/00

(52) U.S. Cl. CPC G05B 19/18; B43K 23/001; G05B 2219/45134; B43K 5/00

(57) ABSTRACT

A marker device is provided for use with a horizontally disposed CNC layout table. The device of this invention is a one-piece device for supporting a tubular ink marker tube above the surface of the layout table. The device includes means for yieldably urging the marker tip of the ink marker tube downwardly into contact with the item being marked.

### BACKGROUND OF THE INVENTION

### Field of the Invention

This invention relates to a marking device for use with a CNC (computer numerical controlled) layout table.

### Description of the Related Art

Many types of marking devices have been previously provided for use with CNC machines. See for example U.S. Pat. Nos. 5,775,215 and 8,272,794. See also U. S. Publication Nos.: 2010/0275794 and 2019/0168584. The prior art marking devices are extremely complicated, cumbersome and expensive. Further, the prior art marking devices are difficult to maintain, repair and/or replace.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A marker device is described for use with a horizontally disposed CNC layout table. The marker device includes a vertically disposed flat mounting plate having a rearward side, a forward side, an upper end, a lower end, a first end and a second end. The marker device also includes a vertically disposed and generally triangular-shaped first side plate having a vertically disposed rearward end having an upper end and a lower end. The upper end of the rearward end of the first side plate is secured to the forward side of the flat mounting plate at the first end thereof. The first side plate also includes a horizontally disposed lower end having a rearward end and a forward end with the lower end thereof extending forwarding from the lower end of the rearward end of the first side plate. The forward end of the first side plate extends upwardly and rearwardly from the forward end of the lower end of the first side plate to the upper end of the first side plate.

The marker device also includes a vertically disposed and generally triangular-shaped second side plate having a vertically disposed rearward end with an upper end and a lower end. The second side plate also includes an upper end at the rearward end thereof which is secured to the forward side of the flat mounting plate at the second end of the mounting plate. The second side plate also includes a horizontally disposed lower end having a rearward end and a forward end with the lower end thereof extending forwardly from the lower end of the rearward end of the second side plate. The second side plate also includes a forward end which extends outwardly and rearwardly from the forward end of the lower end of the second side plate to the upper end of the second side plate.

The marker device also includes a horizontally disposed bottom wall having a rearward end, a forward end, a first side, a second side, an upper side and a lower side with the first side of the bottom wall being secured to the lower end of the first side plate and the second side of the bottom wall being secured to the lower end of the second side wall. The bottom wall has a vertically disposed cylindrical opening formed therein which has an upper end and a lower end.

The marker device also includes a vertically disposed hollow cylindrical first tube, having an upper end and a lower end, with the first tube being positioned in the cylindrical opening in the bottom wall so that the upper end of the first tube is positioned above the upper side of the bottom wall and so that the lower end of the first tube is positioned below the lower side of the bottom wall. The first tube is selectively vertically movably secured to the bottom wall. The lower end of the first tube has a shoulder positioned therein with the shoulder having a central opening formed therein which has a diameter which is less than the inside diameter of the first tube.

The marker device is adapted to be used with an elongated and vertically disposed ink marker tube, having an upper end and a lower end, with the marker tube having a reduced diameter marking tip which extends downwardly from the lower end of the marker tube. The marker tube is selectively removably positioned in the first tube with the shoulder thereof limiting the downward movement of the marker tube whereby the marking tip is positioned below the lower end of the first tube.

The device also includes a vertically disposed and hollow cylindrical second tube having an upper end and a lower end with the second tube being slidably mounted on the upper end of the marker tube. The upper end of the second tube has a restricted opening formed therein which has a diameter less than the diameter of the marker tube. The second tube is positioned on the upper end of the marker tube to yieldably urge the marker tube downwardly with respect to the first tube while permitting the marker tube to move upwardly with respect thereto.

In the preferred embodiment, the marker device is of one-piece plastic construction. In the preferred embodiment, the mounting plate has a plurality of spaced-apart fastener openings formed therein. In the preferred embodiment, the first and second tubes are comprised of metal.

It is therefore a principal object of the invention to provide an improved marker device for use with a CNC layout table.

A further object of the invention is to provide a marker device for use with a CNC layout table which is preferably of one-piece plastic construction and which is adapted to have a marker tube inserted downwardly therein.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a partial perspective view of the marker device of this invention being used with a CNC layout table;

FIG. 2 is a perspective view of the marker device of this invention;

FIG. 3 is an exploded perspective view of the marker device of this invention;

FIG. 4 is a top view of the marker device of this invention;

FIG. 5 is a front view of the marker device of this invention;

FIG. 6 is a side view of the marker device which illustrates the marker tip of a marker pen extending downwardly from the lower end of the lower tube of the marker device of this invention;

FIG. 7 is a perspective view of the marker device of this invention with the marker tip of the marker pen thereof creating markings on a layout table;

FIG. 8A is a partial side sectional view of the marker device of this invention prior to the marking pen being lowered to its marking position; and

FIG. 8B is a view similar to FIG. 8A except that the marking device of this invention has been lowered so that the marking tip of the marker pen is in engagement with an item on the layout table.

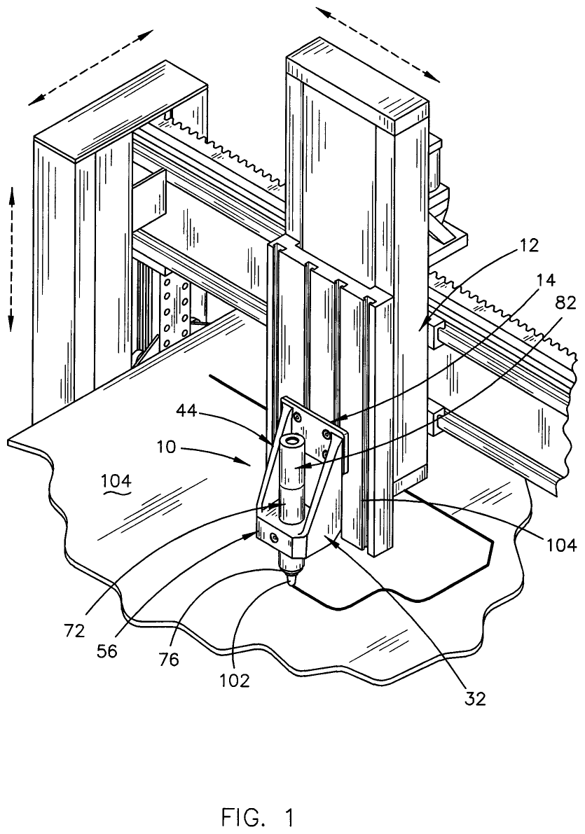

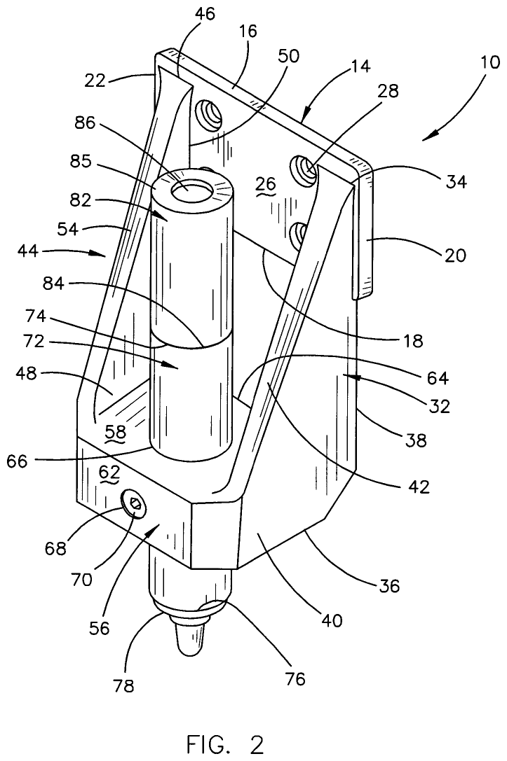

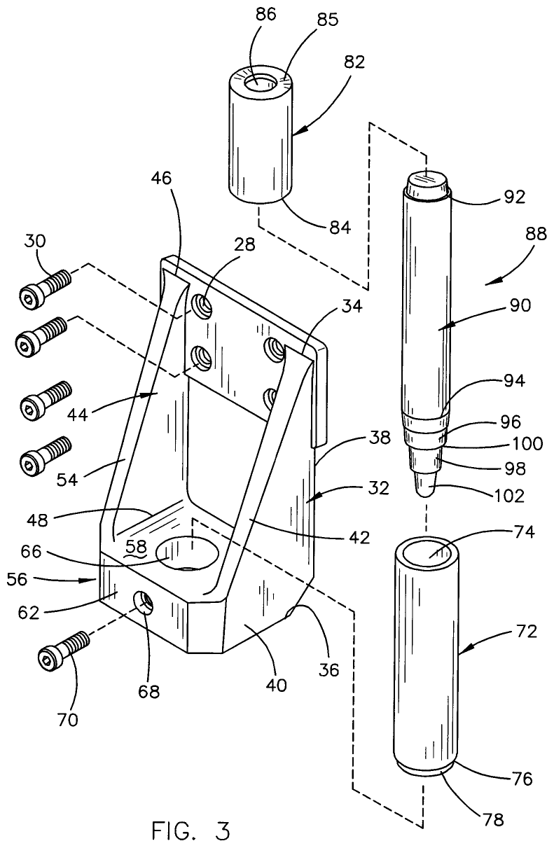

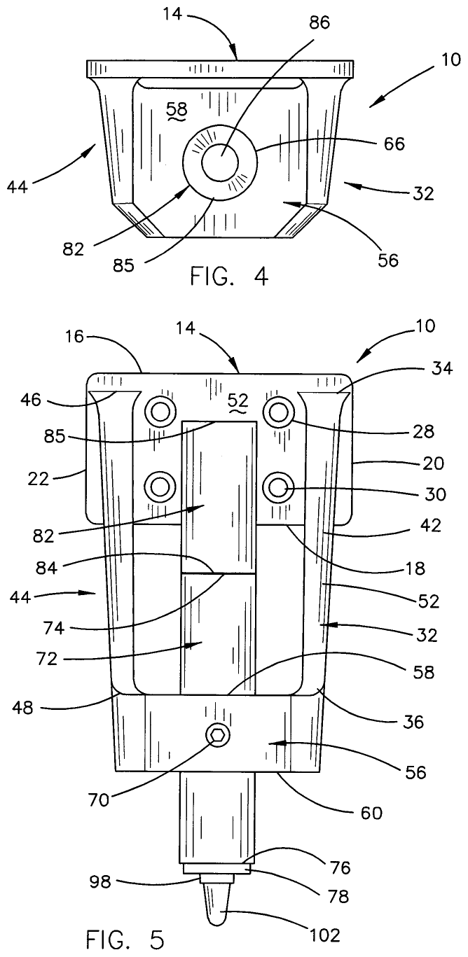

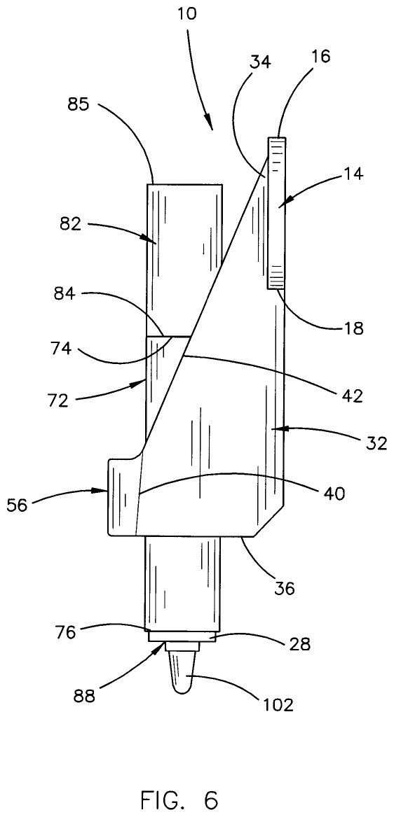

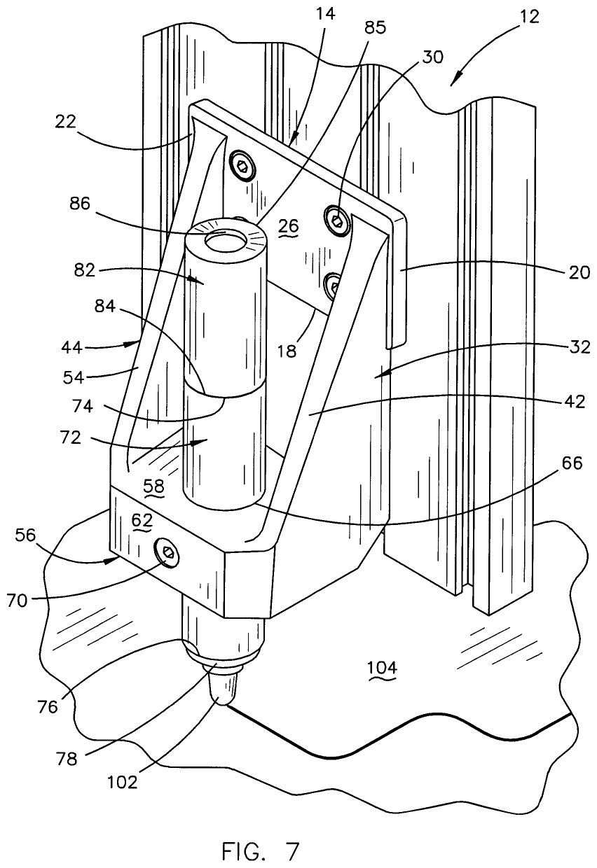

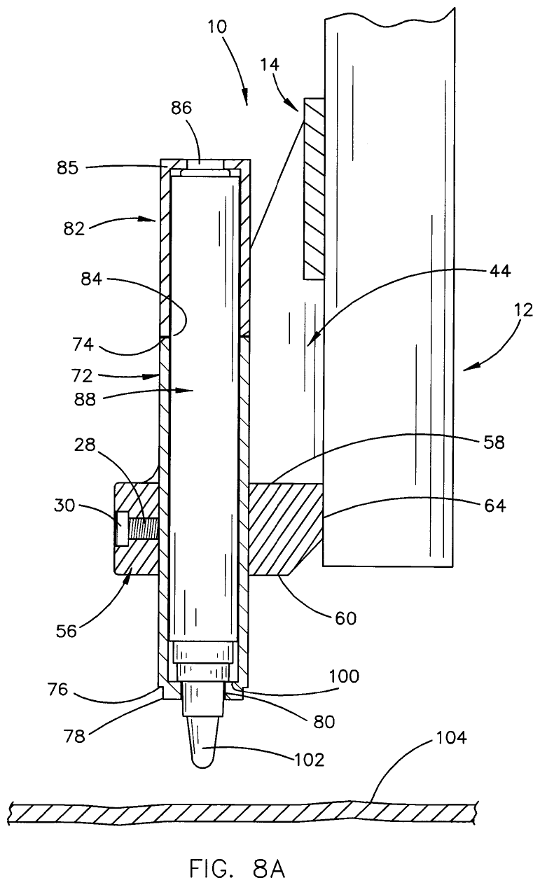

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The number 10 refers to the marker device of this invention which is designed to be used with a CNC layout table assembly 12. Marker device 10 is preferably of one-piece molded plastic but could be comprised of multiple pieces secured together. Marker device 10 includes a vertically disposed mounting plate 14 which has an upper end 16, a lower end 18, a first side edge 20, a second side edge 22, an inner side 24 and an outer side 26. Mounting plate 14 preferably has a plurality of bolt or screw openings 28 formed therein in a spaced-apart manner which are configured to have mounting bolts or screws 30 extending therethrough.

Marker device 10 includes a vertically disposed and generally triangular-shaped first side plate 32 having an upper end 34, a lower end 36, and an inner end 38 and an outer end 40. The first side plate 32 is molded with mounting plate 14. First side plate 32 also includes an inclined portion 42 which extends downwardly and outwardly from the upper end 34 of first side plate 32 to the outer end 40 of first side plate 32.

Marker device 10 also includes a vertically disposed and generally triangular-shaped second side plate 44 having an upper end 46, a lower end 48, with an inner end 50 and an outer end 52. The second side plate 44 is molded with mounting plate 14. Side plate 44 also includes an inclined portion 54 which extends downwardly and outwardly from the upper end 46 of side plate 44 to the outer end 52 of side plate 44. Although it is preferred that the side plates 32 and 44 are triangular, they could take other shapes such as rectangular, square, etc.

The numeral 56 refers to a horizontally disposed bottom wall which is molded with side plates 32 and 44 and which extends therebetween as seen in the drawings. For purposes of description, the solid bottom wall 56 will be described as having an upper end 58, a lower end 60, an outer end 62 and an inner end 64. Bottom wall 56 has a vertically disposed central opening 66 formed therein which extends between the upper and lower ends thereof. A horizontally disposed and internally threaded opening 68 extends inwardly into bottom wall 56 into central opening 66. A set screw 70 is threadably mounted in bore 68 with the inner end thereof selectively extending into central opening 66. The marker device 10 is preferably comprised of plastic as stated above but could be comprised of iron, steel or aluminum.

The numeral 72 refers to an elongated hollow metal and cylindrical lower tube having upper end 74 and a lower end 76. Preferably, lower tube 72 is comprised of aluminum. A washer-like member 78 is secured to the lower end 74 of tube 72 and has an opening 80 formed therein which has a diameter less than the open upper end of tube 72. Tube 72 is inserted into the central opening 66 of bottom wall 56 and is positioned therein so that the upper end 74 of tube 72 is positioned above bottom wall 56 and so that the lower end 74 of tube 72 is positioned below bottom wall 56. Tube 72 selectively vertically adjustably secured to bottom wall 56 by the set screw 70, the inner end of which engages tube 72 to maintain tube 72 in the desired vertical position.

The numeral 82 refers to an elongated hollow metal and cylindrical upper tube which has the same outer diameter as tube 72. Preferably tube 82 is comprised of aluminum. Tube 82 includes an open lower end 84 having the same diameter as the open upper end of tube 72. The upper end 85 of tube 82 has an opening 86 formed therein which has a diameter smaller than the inside diameter of tube 82.

The numeral 88 refers to an off-the-shelf ink marker pen of conventional design. Pen 88 will be described as being vertically disposed. Pen 88 includes a barrel portion 90 having an upper end 92 and a lower end 94. Pen 88 includes a first reduced diameter portion 96 which extends downwardly from lower end 94. Pen 88 also includes a second reduced diameter portion 98 which extends downwardly from the lower end of reduced diameter portion 98 thereby creating a shoulder 100 therebetween. Marker tip 102 extends downwardly from shoulder 100 and has a smaller diameter than shoulder 100.

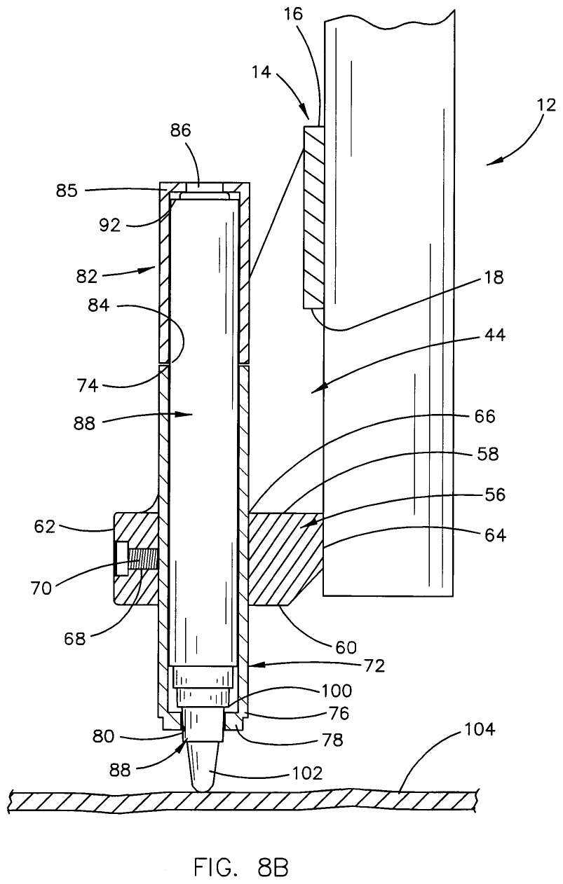

The marker device 10 is secured to the marker head 104 or other component of the CNC machine by bolts or screws 30 extending through bolt openings 28. A marker pen 38 is then extended downwardly into tube 72 until shoulder 100 engages the washer-like member 78 with marker tip 102 extending downwardly through opening 80 in member 78. The upper tube 82 is then slipped downwardly over the upper end of pen 88 until the lower end 84 of upper tube 82 engages the upper end 74 of tube 72. At that time, the marker tip 102 will be positioned above the layout table 104 of assembly 12 as seen in FIG. 8A. The CNC layout table assembly 12 is then lowered until the marker tip 102 engages the item on layout table 104. The CNC layout table assembly 12 is then further lowered to the position of FIG. 8B whereby the lower end of pen 88 is positioned above the shoulder 100 so that the marker tip 102 floats on the layout table 104 as seen in FIG. 8B. At that time, the upper end 92 of pen 88 engages the upper end 85 of tube 82 so that the lower end 84 of tube 82 is separated from the upper end 74 of tube 72. Thus, tube 82 acts as a weight on the marker pen 88 to yieldably maintain the marker tip 102 in engagement with the layout table 104 so that proper weight is applied to the marker tip 102.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A marker device for use with a horizontally disposed CNC layout table, comprising:
a vertically disposed flat mounting plate having a rearward side, a forward side, an upper end, a lower end, a first end and a second end;
a vertically disposed and generally triangular-shaped first side plate having:
(a) a vertically disposed rearward end having an upper end and a lower end;
(b) said upper end of said rearward end of said first side plate being secured to said forward side of said flat mounting plate at said first end of said mounting plate;
(c) a horizontally disposed lower end having a rearward end and a forward end;
(d) said lower end extending forwardly from said lower end of said rearward end of said first side plate;
(e) a forward end extending upwardly and rearwardly from said forward end of said lower end of said first side plate to said upper end of first side plate;
a vertically disposed and generally triangular-shaped second side plate having:
(a) a vertically disposed rearward end having an upper end and a lower end;
(b) said upper end of said rearward end of said second side plate being secured to said forward side of said flat mounting plate at said second end of said mounting plate;
(c) a horizontally disposed lower end having a rearward end and a forward end;
(d) said lower end extending forwardly from said lower end of said rearward end of said second side plate;
(e) a forward end extending upwardly and rearwardly from said forward end of said lower end of said second side plate to said upper end of said second side plate;
a horizontally disposed bottom wall having a rearward end, a forward end, a first side, a second side, an upper side and a lower side;
said first side of said bottom wall being secured to said lower end of said first side plate;
said second side of said bottom wall being secured to said lower end of said second side wall;
said bottom wall having a vertically disposed cylindrical opening formed therein which has an upper end and a lower end;
a vertically disposed hollow and cylindrical first tube, having an upper end and a lower end;
said first tube being positioned in said cylindrical opening in said bottom wall so that said upper end of said first tube is positioned above said upper side of said bottom wall and so that said lower end of said first tube is positioned below said lower side of said bottom wall;
said first tube being selectively vertically movably secured to said bottom wall;
said lower end of said first tube having a shoulder positioned therein with said shoulder having a central opening formed therein which has a diameter which is less than the inside diameter of said first tube;
an elongated and vertically disposed ink marker tube, having an upper end and a lower end;
said marker tube having a reduced diameter marking tip which extends downwardly from said lower end of said marker tube;
said marker tube being selectively removably positioned in said first tube with said shoulder limiting the downward movement of said marker tube whereby said marking tip is positioned below said lower end of said first tube; and
a vertically disposed and hollow cylindrical second tube having an upper end and a lower end;
said second tube being slidably mounted on said upper end of said marker tube;
said upper end of said second tube having a restricted opening formed therein which has a diameter less than the diameter of said marker tube; and
said second tube being positioned on said upper end of said marker tube to yieldably urge said marker tube downwardly with respect to said first tube while permitting said marker tube to move upwardly with respect thereto.

2. The marker device of claim 1 wherein the marker device is of one-piece plastic construction.

3. The marker device of claim 1 wherein said mounting plate has a plurality of spaced-apart fastener openings formed therein.

4. The marker device of claim 1 wherein said first and second tubes are comprised of metal.

5. A marker device of one-piece plastic construction for use with a horizontally disposed CNC layout table, comprising:
a vertically disposed flat mounting plate having a rearward side, a forward side, an upper end, a lower end, a first end and a second end;
a vertically disposed first side plate having an upper end, a lower end, a rearward end and a forward end;
said first side plate extending downwardly and forwardly from said mounting plate at said first end of said mounting plate;
a vertically disposed second side plate having an upper end, a lower end, a rearward end and a forward end;
said second side plate extending downwardly and forwardly from said mounting plate at said second end of said mounting plate;
a horizontally disposed bottom wall extending between said lower ends of said first and second side plates at said forward ends thereof;
said bottom wall having a rearward end, a forward end, a first side, a second side, an upper side and a lower side;
said bottom wall having a vertically disposed cylindrical opening formed therein which has an upper end and a lower end;
a vertically disposed hollow and cylindrical first tube, having an upper end and a lower end;
said first tube being positioned in said cylindrical opening in said bottom wall so that said upper end of said first tube is positioned above said upper side of said bottom wall and so that said lower end of said first tube is positioned below said lower side of said bottom wall;
said first tube being selectively vertically movably secured to said bottom wall;
said lower end of said first tube having a shoulder positioned therein with said shoulder having a central opening formed therein which has a diameter which is less than the inside diameter of said first tube;
a vertically disposed and hollow cylindrical second tube having an upper end and a lower end;
said second tube having the same diameter as said first tube whereby said second tube may be positioned on said upper end of said first tube;
said first and second tubes being configured to have an elongated and vertically disposed ink marker tube, having an upper end and a lower end, positioned thereon when said second tube is positioned on said first tube;
said lower end of said first tube being configured to limit the downward movement of the marker tube and to permit the marker tip of the marker tube to pass therethrough;
said lower end of said first tube having an opening formed therein which permits the lower end of the marker tube to extend therethrough; and
said upper end of said second tube being partially closed for engagement with the upper end of the ink marker tube to urge the marker tip into engagement with the object being marked.
